(19) United States
(12) Patent Application Publication
(10) Pub. No.: US 2026/0025208 A1
(43) Pub. Date: Jan. 22, 2026

(54) OPTICAL TRANSCEIVER, OPTICAL TRANSMISSION SYSTEM, AND CARRIER INTERVAL CONTROL METHOD OF OPTICAL TRANSCEIVER

(71) Applicant: Fujitsu Limited, Kawasaki-shi (JP)

(72) Inventor: Jun MATSUI, Kawasaki (JP)

(73) Assignee: Fujitsu Limited, Kawasaki-shi (JP)

(21) Appl. No.: 19/240,103

(22) Filed: Jun. 17, 2025

(30) Foreign Application Priority Data
Jul. 19, 2024 (JP) 2024-116063

(51) Int. Cl. H04B 10/40; H04B 10/548; H04B 10/61; H04J 14/02

(52) U.S. Cl. CPC H04B 10/40; H04B 10/548; H04B 10/61; H04J 14/02

(57) ABSTRACT

A transceiver has optical modulators that generate optical signals by optically modulating, based on data, multifrequency light output by a multiwavelength light source; and an optical multiplexer that has a first channel frequency interval and multiplexes and outputs the optical signals. The transceiver further has an optical demultiplexer that has a second channel frequency interval and demultiplexes a received optical signal; and optical receivers that perform coherent detection with respect to the optical signals and demodulate the data. The transceiver further has a controller that performs control of a carrier interval of the multiwavelength light source so that the optical power of the output optical signals of optical demultiplexer is maximized and the controller adjusts deviation of the channel frequency interval of the optical multiplexer with respect to the carrier interval.

### CROSS REFERENCE TO RELATED APPLICATIONS

This application is based upon and claims the benefit of priority of the prior Japanese Patent Application No. 2024-116063, filed on Jul. 19, 2024, the entire contents of which are incorporated herein by reference.

### FIELD OF THE INVENTION

The embodiments discussed herein are related to an optical transceiver, an optical transmission system, and a carrier interval control method of an optical transceiver.

### BACKGROUND OF THE INVENTION

The introduction of multi-band transmission technology is progressing to increase the number of wavelength multiplexed channels and expand transmission capacities for the ever-increasing traffic of optical networks. A multicarrier optical transceiver uses a multiwavelength light source such as a comb light source in a transmitter, transmits coherent light with orthogonal polarization in which a signal is modulated by the phase and amplitude of multiple carriers, and performs coherent detection and demodulation of multiple signals at a receiver.

As a prior art, for example, there is a technique of detecting frequency mismatch between the transmission and reception of a multifrequency optical signal obtained using an optical frequency comb source and matching the phase of local light to the input signal, the frequency mismatch being detected by observing beat frequency components generated on the reception side (for example, refer to Published Japanese-Translation of PCT Application, Publication No. 2009-524351 and U.S. Patent Application Publication No. 2007/0166048). Further, there is a technique of transmitting a reference light and a modulated signal created by phase modulation, in multiple sidebands generated by an optical frequency comb generator on the transmission side while on the reception side, the modulated signal is demodulated based on multiple sidebands created based on the reference light by an optical frequency comb generator on the reception side (for example, refer to Japanese Laid-Open Patent Publication No. 2003-298553). Further, there is a technique in which the transmission side generates a frequency comb signal containing pilot tone and optical tone by a frequency comb source and transmits the optical tone as coherent light; and the reception side uses a frequency comb source driven by the pilot tone and demodulates the coherent light (for example, refer to U.S. patent Ser. No. 11/750,357).

### SUMMARY OF THE INVENTION

According to an aspect of an embodiment, an optical transceiver includes: a multiwavelength light source configured to output multifrequency light and having a predetermined carrier interval; a transmitter; a receiver; and a controller. The transmitter has: a plurality of optical modulators that generate a plurality of optical signals by optically modulating, based on data, the multifrequency light output by the multiwavelength light source; and an optical multiplexer that has a first channel frequency interval and multiplexes the plurality of optical signals output by the plurality of optical modulators, the optical multiplexer outputting the multiplexed plurality of optical signals to a first optical transmission path for transmission. The receiver has: an optical demultiplexer that has a second channel frequency interval and demultiplexes an optical signal of a second optical transmission path for reception, into the plurality of optical signals; and a plurality of optical receivers that perform coherent detection with respect to the plurality of optical signals output by the optical demultiplexer, and demodulate the data, the coherent detection being performed using the multifrequency light of the multiwavelength light source. The controller is configured to perform control of the carrier interval of the multiwavelength light source and adjust the first channel frequency interval of the optical multiplexer of the transmitter with respect to the carrier interval, the control being performed based on an optical power of the plurality of optical signals output by the optical multiplexer of the receiver.

An object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an example of a configuration of an optical transceiver of an embodiment.

FIG. 2 is a diagram of a system configuration and problems of a comparison example.

FIG. 3 is a diagram depicting refractive index distribution at a wafer surface in silicon photonics.

FIG. 4 is a diagram depicting signal degradation due to frequency interval deviation of Mxs/Dmxs of a pair of transmitting and receiving transceivers.

FIG. 5A is a diagram for explaining Q factor degradation due to frequency interval deviation of the Mx/Dmx of the pair of transmitting and receiving transceivers.

FIG. 5BA is a diagram for explaining Q factor degradation due to frequency interval deviation of the Mx/Dmx of the pair of transmitting and receiving transceivers.

FIG. 5BB is a diagram for explaining Q factor degradation due to frequency interval deviation of the Mx/Dmx of the pair of transmitting and receiving transceivers.

FIG. 6A is a diagram for describing carrier interval control of the embodiment.

FIG. 6B is a diagram for describing carrier interval control of the embodiment.

FIG. 7A is a diagram of power fluctuation due to deviation of a channel frequency interval.

FIG. 7B is a diagram of power fluctuation due to deviation of the channel frequency interval.

FIG. 8 is a diagram depicting an example of a hardware configuration of a controller of an optical transceiver.

FIG. 9 is a flowchart depicting an example of control by the controller.

FIG. 10 is a diagram depicting an example of overall control of an optical transmission system of the embodiment.

FIG. 11A is a sequence diagram of the example of overall control of the optical transmission system of the embodiment.

FIG. 11B depicts an example of frequency control of VCOs 113, corresponding to the control example depicted in FIG. 10.

FIG. 11C depicts an example of frequency control of the VCOs 113, corresponding to the control example depicted in FIG. 10.

FIG. 11D depicts an example of frequency control of the VCOs 113, corresponding to the control example depicted in FIG. 10.

FIG. 11E depicts an example of frequency control of the VCOs 113, corresponding to the control example depicted in FIG. 10.

FIG. 11F depicts an example of frequency control of the VCOs 113, corresponding to the control example depicted in FIG. 10.

FIG. 12A is a diagram depicting an example of convergence by performing the control according to the embodiment.

FIG. 12BA1 is a diagram depicting spectrum distribution of an outermost channel before control.

FIG. 12BA2 is a diagram depicting the spectrum distribution of the outermost channel before control.

FIG. 12BB1 is a diagram depicting the spectrum distribution of the outermost channel after control.

FIG. 12BB2 is a diagram depicting the spectrum distribution of the outermost channel after control.

FIG. 13AA is a diagram for describing effects obtained by the embodiment.

FIG. 13AB is a diagram for describing effects obtained by the embodiment.

FIG. 13B is a diagram for describing effects obtained by the embodiment.

FIG. 14 is a diagram depicting an example of a configuration of an optical transceiver of a second embodiment.

FIG. 15 is a diagram depicting an example of overall control of an optical transmission system of the second embodiment.

FIG. 16A is a sequence diagram of the example of overall control of the optical transmission system of the second embodiment.

FIG. 16BA is a diagram depicting an example of frequency control of VCOs of the second embodiment.

FIG. 16BB is a diagram depicting an example of the frequency control of the VCOs of the second embodiment.

FIG. 16BC is a diagram depicting an example of the frequency control of the VCOs of the second embodiment.

FIG. 16BD is a diagram depicting an example of the frequency control of the VCOs of the second embodiment.

FIG. 16BE is a diagram depicting an example of the frequency control of the VCOs of the second embodiment.

FIG. 16BF is a diagram depicting an example of the frequency control of the VCOs of the second embodiment.

### DESCRIPTION OF THE INVENTION

First, problems associated with the conventional techniques are discussed. In a comparison example, a center frequency of a comb light source and adjustment of a filter phase of a multiplexer ((Mx), optical multiplexer) and a demultiplexer ((Dmx), optical demultiplexer) are controlled by temperature adjustment of arrayed waveguide gratings (AWGs) or the like. However, deviation occurs between a carrier interval of the comb light source and a channel frequency interval of the Mx/Dmx. While described in detail hereinafter, deviation of the channel frequency interval occurs due to variation of refractive index distribution at a surface of a chip configuring the AWG. Frequency deviation of the Mx/Dmx between a pair of transceivers causes signal degradation such as Q factor and places a limitation on the degree of parallelism (carrier count) of the optical transmission.

Embodiments of an optical transceiver, an optical transmission system, and a carrier interval control method of an optical transceiver according to the present disclosure are described in detail with reference to the accompanying drawings. An optical transceiver described in an embodiment is, for example, a multicarrier coherent transceiver configured to transmit multicarrier coherent light. The optical transceiver is disposed at both the transmission side and the reception side of a transmission section of wavelength division multiplexing (WDM) optical transmission system.

At the optical transceiver, a transmitter outputs a frequency-multiplexed optical signal to an optical transmission path, the frequency-multiplexed optical signal being obtained by optically modulating multiple signals to be transmitted and thereby placing the signals on carriers of multiple optical frequency intervals. A receiver extracts multiple signals from an optical signal from the optical transmission path by frequency-demultiplexing, demodulating, and encoding the signals.

While described in detail hereinafter, in the optical transmission system, a pair of the optical transceivers is disposed, one optical transceiver being disposed on the transmission side and the other optical transceiver being disposed on the reception side of a transmission section. For example, the pair of the optical transceivers have a transmitter on the transmission side and a receiver on the reception side of an optical transmission path to an upstream device, and a transmitter on the transmission side and a receiver on the reception side of an optical transmission path to a downstream device. In other words, a single optical transceiver has a transmitter on the transmission side of the optical transmission path to an upstream device and a receiver on the optical transmission path to a downstream device.

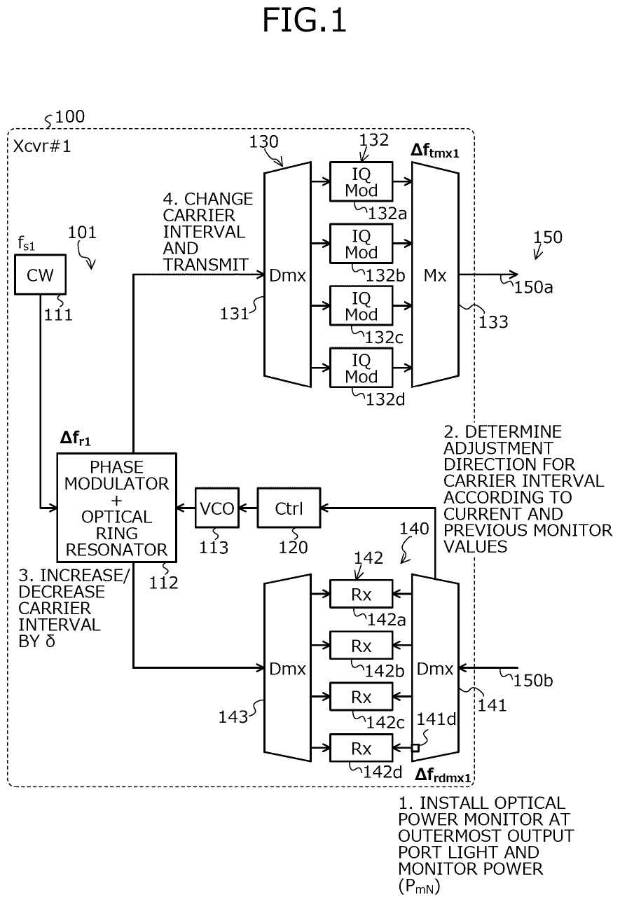

FIG. 1 is a diagram depicting an example of a configuration of an optical transceiver of the embodiment. The optical transceiver (hereinafter, also referred to as transceiver, Xcvr #1) 100 includes a multiwavelength light source 101, a controller (Ctrl) 120, a transmitter 130, and a receiver 140.

The multiwavelength light source 101 of the example depicted in FIG. 1 includes a laser light source 111, a phase modulator (including a ring resonator) 112, and a voltage-controlled oscillator (VCO) 113. The laser light source 111 outputs light of a frequency fₛ₁, for example, continuous wave (CW) light to the phase modulator 112. Based on an output frequency of a clock output by the VCO 113, the phase modulator 112 generates multiple lights (in the example depicted in FIG. 1, four waves) having a carrier interval Δfᵣ₁ and outputs the lights to the transmitter 130 and the receiver 140.

The transmitter 130 includes an optical demultiplexer (Dmx) 131, optical modulators (IQ Mod) 132, and an optical multiplexer (Mx) 133. The optical demultiplexer (Dmx) 131 demultiplexes the light of the carrier interval Δfᵣ₁ output by the phase modulator 112, into multiple components/waves (in the example depicted in FIG. 1, four waves) by a channel frequency interval Δfₜₘₓ₁ corresponding to the carrier interval Δfᵣ₁.

The optical modulators 132 are disposed in a quantity (four modulators) that corresponds to a demultiplexing count (four waves) and each of the optical modulators 132 (132a, 132b, 132c, 132d) adds different data to optical signals by IQ optical modulation, for example, Mach-Zehnder modulators are used. The optical multiplexer (Mx) 133 multiplexes the optical signals output by the four the optical modulators 132 (132a to 132d) and outputs the multiplexed signal to an optical transmission path 150a (for downstream transmission) of an optical transmission path 150. The optical signal output by the optical multiplexer (Mx) 133 is a multichannel optical signal having the channel frequency interval Δfₜₘₓ₁. The optical transmission path 150 is constituted by an optical fiber, optical waveguides, etc.

The receiver 140 includes optical demultiplexers (Dmx) 141, 143 and optical receivers 142. the optical demultiplexer (Dmx) 141 demultiplexes an optical signal transmitted on an optical transmission path 150b (for upstream reception) of the optical transmission path 150 into multiple waves/components (in the example depicted in FIG. 1, four waves) by a channel frequency interval Δfᵣₐₘₓ₁ and outputs the waves/components to the optical receivers 142.

The optical demultiplexer (Dmx) 141 has an optical monitor that detects the optical power of an optical signal at output ports that perform demultiplexing and output. In the example depicted in FIG. 1, the optical demultiplexer (Dmx) 141 has an optical monitor 141d provided at an outermost output port for received optical signals and thereby detects an optical power (P_{mN}) thereof. The outermost output port is an output port that outputs a subcarrier of an optical signal, a subcarrier whose center frequency of the optical spectrum is largest or smallest, in other words, a subcarrier of an end of the signal band.

The optical demultiplexer (Dmx) 143 demultiplexes light having the carrier interval Δfᵣ₁ output by the phase modulator 112, the light being demultiplexed into multiple wave/components (in the example depicted in FIG. 1, four waves) by the channel frequency interval Δfᵣₐₘₓ₁ corresponding to the carrier interval Δfᵣ₁ and output to the optical receivers 142 as LO light.

The optical receivers 142 are disposed in a quantity (four optical receivers) that corresponds to the demultiplexing count (four waves) and the optical receivers 142 (142a, 142b, 142c, 142d) demodulate optical signals of channels of the demultiplexed four waves by coherent detection using the LO light of the multiwavelength light source 101.

Further, in the embodiment, the optical multiplexer (Mx) 133 of the transmitter 130 and the optical demultiplexer (Dmx) 141 of the receiver 140 may be formed on a single optical integrated circuit (single optical chip).

The multiwavelength light source 101 suffices to output multiple lights having the carrier interval Δfᵣ₁ and may be configured with an array light source that outputs lights of multiple frequencies. In an instance in which an array light source is used as the multiwavelength light source 101, lights of multiple frequencies are output directly to the optical modulators 132 and the optical receivers 142. In this instance, the optical demultiplexers (Dmxs) 131, 143 depicted in FIG. 1 are unnecessary.

The controller (Ctrl) 120 functions as a control unit for controlling the carrier interval Δfᵣ₁ of output by the phase modulator 112. The controller (Ctrl) 120 implements the following control 1. to 4. 1. The controller (Ctrl) 120 detects the optical power (P_{mN}) for the outermost frequency, using the optical monitor 141d of the optical demultiplexer (Dmx) 141 of the receiver 140. 2. The controller (Ctrl) 120 compares the current monitor value and the previous monitor value detected by the optical monitor 141d and determines a direction of adjustment for (determines to increase or decrease) the carrier interval Δfᵣ₁ so that the value of the optical power detected by the optical monitor 141d is maximized. 3. Adjusts (increases or decreases) the carrier interval Δfᵣ₁ output by the phase modulator 112 of the transmitter 130 by a predetermined amount (δ) according to the direction of adjustment determined for the carrier interval Δfᵣ₁. 4. As a result, the transmitter 130 outputs, to the optical transmission path 150a, an optical signal to which the optical multiplexer (multiplexer: Mx) 133 imparts the channel frequency interval Δfₜₘₓ₁.

The controller (Ctrl) 120 repeatedly performs the control 1. to 4. above and thereby optimizes the carrier interval Δfᵣ₁ (the channel frequency interval Δfₜₘₓ₁ of the transmitter 130). The necessity of optimizing the carrier interval Δfᵣ₁ (the channel frequency interval Δfₜₘₓ₁ of the transmitter 130) is described hereinafter with the comparison example and problems.

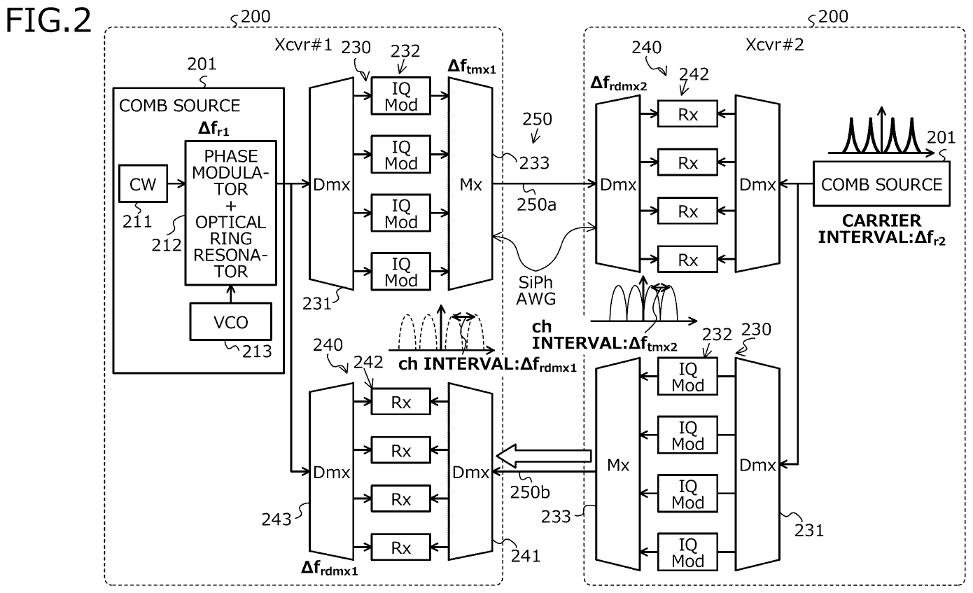

FIG. 2 is a diagram of a system configuration and problems of the comparison example. In FIG. 2, an example of a system configuration is depicted in which a pair of transceivers 200 is disposed with an optical transmission path 250 therebetween. In each of the transceivers 200, components identical to those depicted in FIG. 1 are depicted having reference characters thereof being replaced with reference characters in the 200's.

Description of the configuration of one transceiver 1 (Xcvr #1) 200 is given, in the transceiver 1 (Xcvr #1) 200, a multiwavelength light source 201 outputs multiple lights (four waves) having the carrier interval Δfᵣ₁ to a transmitter 230 and a receiver 240.

The transmitter 230 outputs, to the optical transmission path 250a, an optical signal having the channel frequency interval Δfₜₘₓ₁, by an optical multiplexer (Mx) 233. The receiver 240 wavelength-demultiplexes an optical signal input from the optical transmission path 250b into waves/components having the channel frequency interval Δf_{rdmx1}, by an optical demultiplexer (Dmx) 241.

The other transceiver 2 (Xcvr #2) 200 has a same configuration as that of the transceiver 1 (Xcvr #1) and the multiwavelength light source 201 thereof outputs, to the transmitter 230 and the receiver 240, multiple lights (four waves) having a carrier interval Δfᵣ₂.

The receiver 240 wavelength-demultiplexes an optical signal input from the optical transmission path 250a into waves/components having the channel frequency interval Δfᵣₐₘₓ₂, by the optical demultiplexer (Dmx) 241. The transmitter 230 outputs, to the optical transmission path 250b, an optical signal having a channel frequency interval Δfₜₘₓ₂, by the optical multiplexer (Mx) 233.

The optical multiplexer (Mx) 233 and the optical demultiplexer (Dmx) 241, for example, are formed by an arrayed waveguide grating (AWG) by a silicon photonics (SiPh) technique. The center frequency of the multiwavelength light source 201 such as a comb light source and adjustment of a filter phase of the optical multiplexer (Mx) 233 and the optical demultiplexer (Dmx) 24 are controlled by temperature adjustment of the AWG.

However, in the comparison example, an occurrence of deviation in frequency between a carrier interval of the multiwavelength light source 201 and a channel frequency interval of the optical multiplexer (Mx) 233 and the optical demultiplexer (Dmx) 241 is not considered.

Assuming the carrier interval to be Δfₘ and a design value (fixed value) of Mx/Dmx channel frequency intervals to be Δfₜₘₓₙ, Δf_{rdmxn}, then in the same transceivers 200 (in the same optical IC), Δfₜₘₓₙ˜Δf_{rdmxn} (up to 0.1% deviation).

In an optical signal seen in optical transmission on the optical transmission path 250b to a downstream device, error of 1% (1 GHz with respect to 100 GHz, described in detail hereinafter) occurs in a wavelength interval between the carrier interval Δfᵣ₂ of the transmitter 230 on the transmission side (Xcvr #2) and the Mx channel frequency interval Δfₜₘₓ₂. A Dmx channel frequency interval of the receiver 240 on the reception side (Xcvr #1) is Δfₜₘₓ₁ and the carrier interval of the LO light is Δfᵣ₁. The carrier interval Δfᵣ₁ can be compensated by control such as DSP of the reception side (Xcvr #1). In the example depicted in FIG. 2, the channel frequency interval Δfₜₘₓ₂ of the Mx 233 on the transmission side (Xcvr #2) is narrow while the channel frequency interval Δfₜₘₓ₁ of the Dmx 241 of the receiver 240 on the reception side (Xcvr #1) is wide and deviation of 1 GHz occurs.

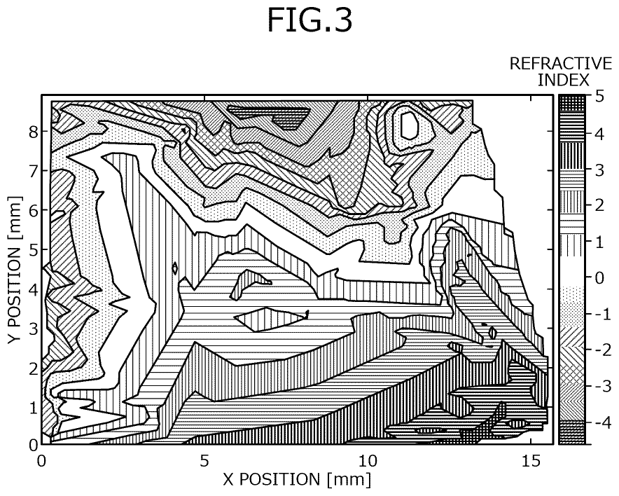

FIG. 3 is a diagram depicting refractive index distribution at a wafer surface in silicon photonics. FIG. 3 is disclosed in FIG. 2(b) of “Impact of Fabrication Non-Uniformity on Chip-Scale Silicon Photonic Integrated Circuits” by L. Chrostowski, et al, Department of Electrical and Computer Engineering, University of British Columbia, V6R 1T3, Canada, Th2A.37.pdf, OFC 2014 OSA 2014 and shows refractive index differing according to position in the wafer surface (X15 mm, Y9 mm).

Here, assuming the signal light wavelength is ∧, a group refractive index of the waveguide is n_{g}, and the difference in length between both arms in an asymmetric MZ (Mach-Zehnder interferometer) is ΔL, then Δf_{dmx}∝λ²/(2×n_{g}×ΔL).

On an area of the wafer surface depicted in FIG. 3, for example, the Mx and the Dmx are cut out at different positions of about 1 mm. Within the wafer surface, when n_{g}=4.225 to 4.265, Ang is up to 1%. In a case of design where Δf_{dmx}=100 GHz, a deviation of about 1 GHz occurs with Δf_{dmx} within the wafer surface depicted in FIG. 3, this is deviation of about 1 GHz occurring between the pair of transmitting and receiving transceivers (Xcvr #2 to Xcvr #1). When this is viewed in terms of the Mx/Dmx corresponding to an optical subcarrier of N wavelengths, the optical frequency position from one end of the frequency band of the optical signal to the other has a deviation of N×1 GHz from the design value.

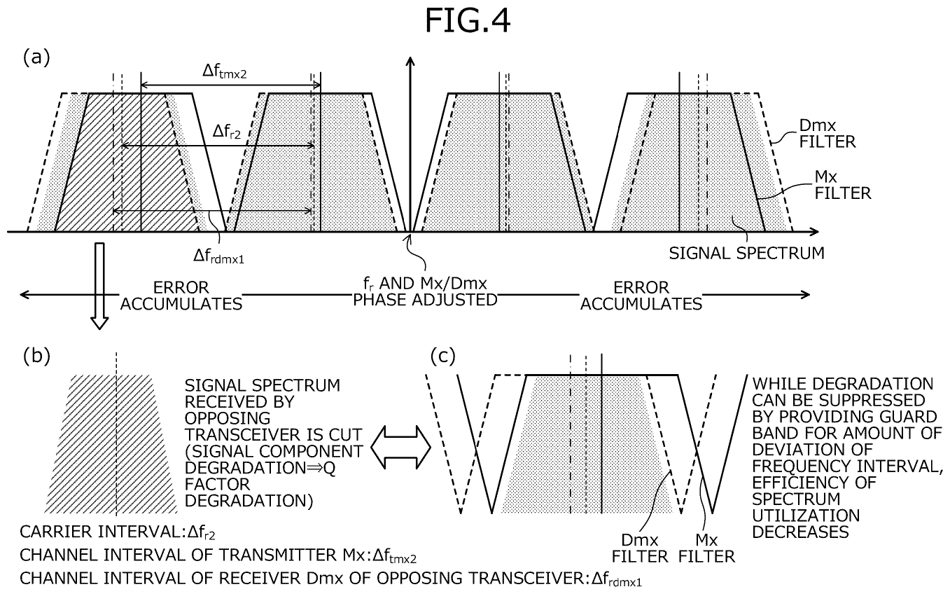

FIG. 4 is a diagram depicting signal degradation due to frequency interval deviation of the Mxs/Dmxs of a pair of transmitting and receiving transceivers. A horizontal axis indicates frequency, and a vertical axis indicates optical power. The optical spectrum of a transmitted optical signal has filter characteristics exhibiting substantially a trapezoidal shape.

In FIG. 4, similar to FIG. 2, optical transmission states are depicted as viewed in terms of an optical signal of the optical transmission path 250b to a downstream device. The carrier interval of the transmitter 230 of the transmission side (Xcvr #2) is assumed to be Δfᵣ₂, the channel frequency interval of the Mx 233 of the transmitter 230 is assumed to be Δfₜₘₓ₂, and the channel frequency interval of the Dmx 241 of the receiver 240 of the opposing reception side (Xcvr #1) is assumed to be Δfᵣₐₘₓ₁. In FIG. 4, the filter characteristics of the Mx 233 of the transmitter 230 are indicated by solid lines and the filter characteristics of the Dmx 241 of the receiver 240 are indicated by dashed lines.

As indicated by (a) in FIG. 4, deviation (error) occurs in the frequency intervals of the filter characteristics of the Mx 233 of the transmitter 230 (solid lines) and the filter characteristics of the Dmx 241 of the receiver 240 (dashed lines). In this case, as indicated by (b) in FIG. 4, the signal spectrum received by the opposing transceiver (Xcvr #1) is cut, the signal band is narrower, and signal components degrade, inviting Q factor degradation.

As for the center wavelength of the signal band, as indicated by (a) in FIG. 4, in the comparison example, while fᵣ of a laser light source 211 and the phases of the Mx/Dmx have been adjusted, frequency deviation error increasingly accumulates closer to the ends of the signal band, thereby increasing the deviation.

Here, as indicated by (c) in FIG. 4, while providing guard bands of an amount corresponding to the amount of frequency interval deviation of the Mx 233 of the transmission side and the Dmx 241 of the reception side suppresses signal degradation, the frequency interval of subcarriers becomes larger and spectral utilization efficiency decreases.

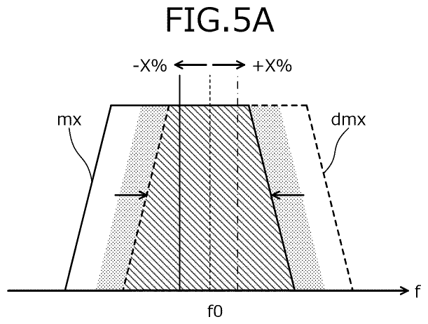

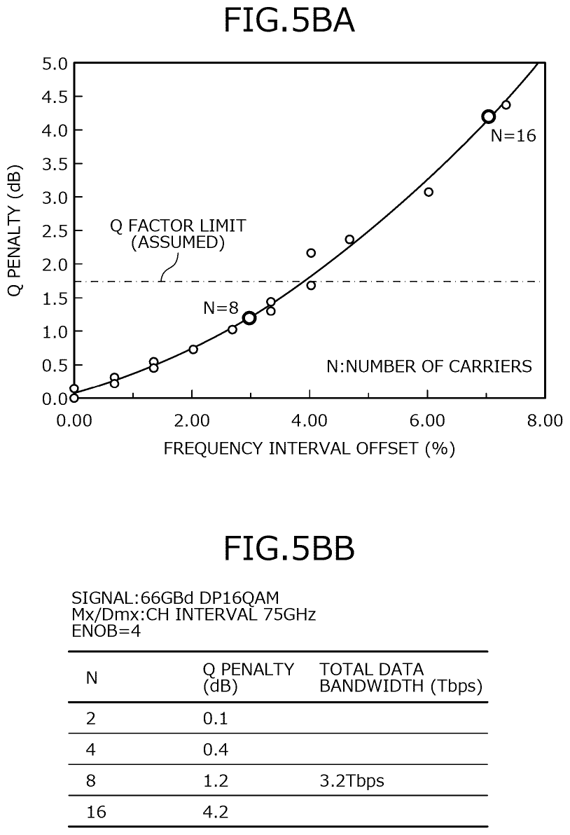

FIGS. 5A, 5BA, and 5BB are diagrams for explaining Q factor degradation due to frequency interval deviation of the Mx/Dmx of a pair of transmitting and receiving transceivers. As depicted in FIG. 5A, a frequency interval deviation (Δfₜₘₓ≠Δf_{rdmx}) of +X % with respect to a subcarrier center frequency f0 is assumed to occur in the filter characteristics of the Mx 233 (solid line) and the filter characteristics of the Dmx 241. In this instance, subcarrier signals become narrower, each being reduced from both sides due to the deviation between (guard bands of) the Mx 233/the Dmx 241 as indicated by an arrow in the drawing. The amount of narrowing is expressed by (N/2−1)×X×CH interval (N: subcarrier count).

Further, when the subcarrier count increases, error of the carrier interval and the channel frequency interval becomes cumulative. In FIG. 5BA, a horizontal axis indicates frequency interval offset (%) and a vertical axis indicates Q factor penalty (dB).

FIG. 5BB shows Q factor penalty (dB) and total data bandwidth (Tbps) according to subcarrier count N. It is assumed that an optical signal to be transmitted is 66GBd, DP16QAM is used, Mx/Dmx channel (frequency) interval is 75 GHz, and ENOB (effective number of bits of DAC/ADC) is 4. DP16QAM is an abbreviation of Dual Polarization 16 Quadrature Amplitude Modulation.

When the subcarrier count N=8 (3.2 Tbps class), the Q factor penalty is a about 1.2 dB. Furthermore, when the subcarrier count N (degree of parallelism) is raised, the Q factor penalty is a few dB.

On the other hand, when there is a limit on the Q factor, a limit occurs with the degree of parallelism (carrier count) due to the Q factor penalty. In FIG. 5BA, while error is correctable up to the Q factor limit when N=8 or less, when N=16, the Q factor limit is exceeded and error cannot be corrected. As described, in the comparison example, when the degree of parallelism is raised and the subcarrier count is increased, occurrence of the Q factor penalty cannot be suppressed.

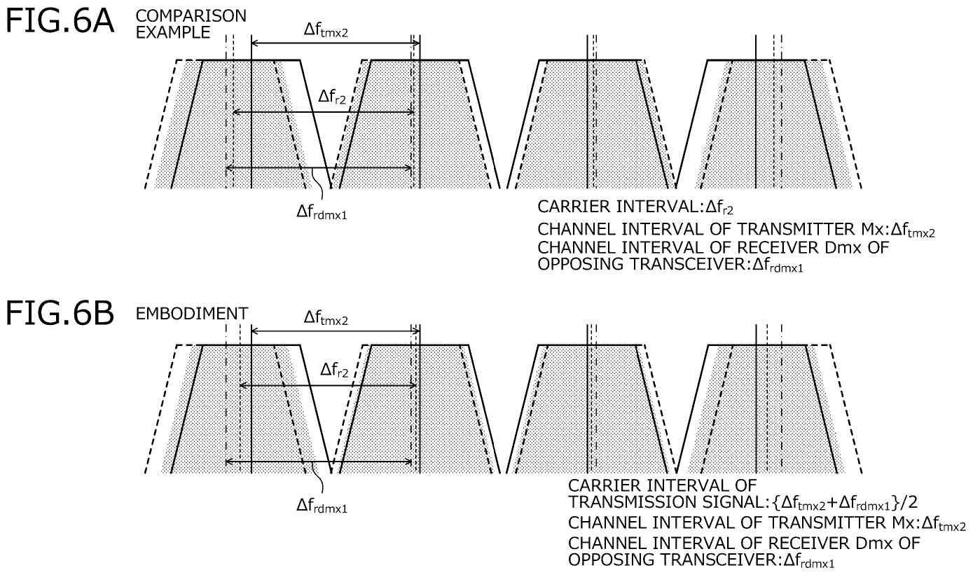

FIGS. 6A and 6B are diagrams for describing carrier interval control of the embodiment. FIG. 6A shows, as a contrast diagram, a same frequency interval deviation as that of the comparison example in (a) in FIG. 4. In the embodiment, to solve the problems above, as depicted in FIG. 6B, the carrier interval Δfᵣ is controlled to be an intermediate value ({Δfₜₘₓ₂+Δf_{rdmx1}}/2) of a channel frequency interval Δfₜₘₓ of the Mx 133 of the transmitter 130 and the channel frequency interval Δf_{rdmx} of the Dmx 141 of the receiver 140. As a result, frequency interval deviation is suppressed and the amount of narrowing described above is reduced.

Further, in the embodiment, in the same transceiver 200 (for example, in the same optical IC of Xcvr #1), the optical multiplexer (Mx) 233 and the optical demultiplexer (Dmx) 241 positioned on the optical transmission path 150 side are formed on the same optical integrated circuit (the same optical chip). As a result, the filter characteristics (error) of the optical multiplexer (Mx) 233 and the optical demultiplexer (Dmx) 241 in the same transceiver 200 can be made nearly the same and frequency interval deviation in the initial state is suppressed to be minimal.

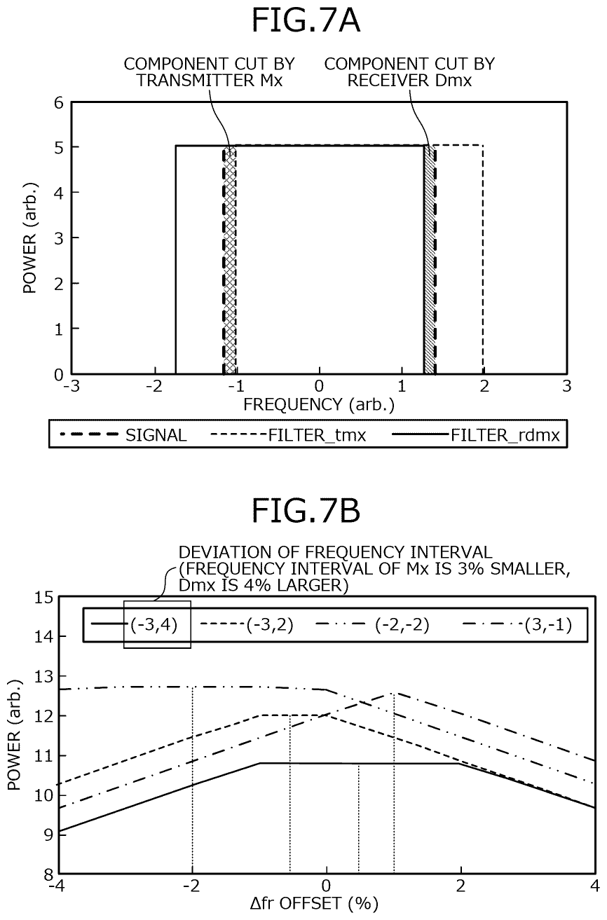

FIGS. 7A and 7B are diagrams of power fluctuation due to deviation of the channel frequency interval. In the embodiment, an example is described in which carrier interval control is performed using power fluctuation due to deviation of the channel frequency interval.

FIG. 7A shows Mx/Dmx filter characteristics, a horizontal axis indicating frequency and a vertical axis indicating the optical power. Mx/Dmx are rectangular filters, estimating a rectangular signal spectrum. The carrier interval is 1.17 times (carrier interval 75 GHZ, rate 64 GBd) the signal band.

FIG. 7B shows other characteristics of deviation of the frequency intervals of the Mx and the Dmx, a horizontal axis indicating frequency interval offset and a vertical axis indicating optical power. For example, characteristic (−3,4) exhibits deviation of the frequency interval in which the Mx frequency interval is 3% smaller and that of the Dmx is 4% larger. Results of calculation of the optical power with respect to frequency offset (%) of the signal spectrum are shown.

According to FIG. 7B, the optical power is maximal when the carrier interval Δfᵣ is a midpoint between the Mx channel frequency interval Δfₜₘₓ and the Dmx channel frequency interval Δf_{rdmx} of the opposing receiver. Further, in an instance in which guard bands are provided, a range of the maximum offset is expanded. Thus, in the embodiment, at the receiver, the optical power of the channels is monitored and the carrier interval Δfᵣ transmitted by the transmitter is controlled, whereby optical control of the carrier interval Δfᵣ becomes possible.

For example, in the example depicted in FIG. 1, the optical monitor 141d of the Dmx 141 of the receiver 140 monitors the maximum value of the optical power of the outermost frequency of the channel frequency interval Δf_{rdmx1} and the controller 120 controls the carrier interval Δfᵣ₁. As indicated by (a) in FIG. 4, in the signal band, the amount of frequency interval deviation of a subcarrier (channel) is greatest at the outermost frequency and thus, detecting and controlling the optical power of the outermost frequency is effective. In the embodiment, as described above, by controlling the carrier interval Δfᵣ₁, the carrier interval Δfᵣ and the channel frequency interval Δfₜₘₓ₁ of the Mx 133 conform with each other by suppressing the frequency interval deviation described above.

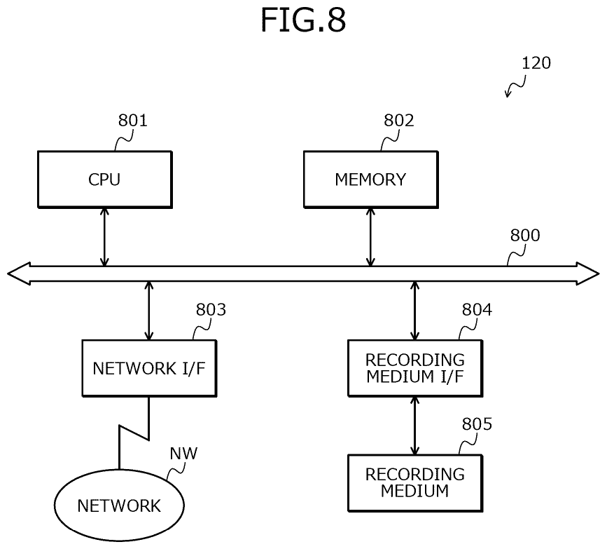

FIG. 8 is a diagram depicting an example of a hardware configuration of the controller of the optical transceiver. An example of a configuration of the controller 120, which corresponds to the control unit of the optical transceiver 100 depicted in FIG. 1 is depicted.

In the example of the configuration depicted in FIG. 8, the controller 120 has a processor 801 such as a central processing unit (CPU), a memory 802, a network interface (IF) 803, a recording medium IF 804, and a recording medium 805. Further, the components are coupled to each other by a bus 800.

Here, the processor 801 is a control unit configured to govern overall control of the optical transceiver 100. The processor 801 may have multiple cores. The memory 802, for example, includes a read-only memory (ROM), a random-access memory (RAM), and a flash ROM. In particular, for example, the flash ROM stores control programs, the ROM stores application programs, and the RAM is used as a work area of the processor 801. Programs stored in the memory 802 are loaded onto the processor 801, whereby encoded processes are executed by the processor 801.

The network IF 803 administers an interface between a network NW and the control unit (the controller 120) and controls the input and output of information with respect to devices external to the optical transceiver 100.

The recording medium IF 804, under the control of the processor 801, controls the reading and writing of data with respect to the recording medium 805. The recording medium 805 stores data written thereto under the control of the recording medium IF 804.

In addition to the above components, the control unit (the controller 120), for example, may be configured to be coupled to an input device, a display, and/or the like via an IF.

The processor 801 depicted in FIG. 8 may implement functions of the controller 120 of the optical transceiver 100 depicted in FIG. 1, by executing a program. The controller 120 may be configured by a field-programmable gate array (FPGA) or an application specific integrated circuit (ASIC). Further, the controller 120 may be configured by a digital signal processor (DSP).

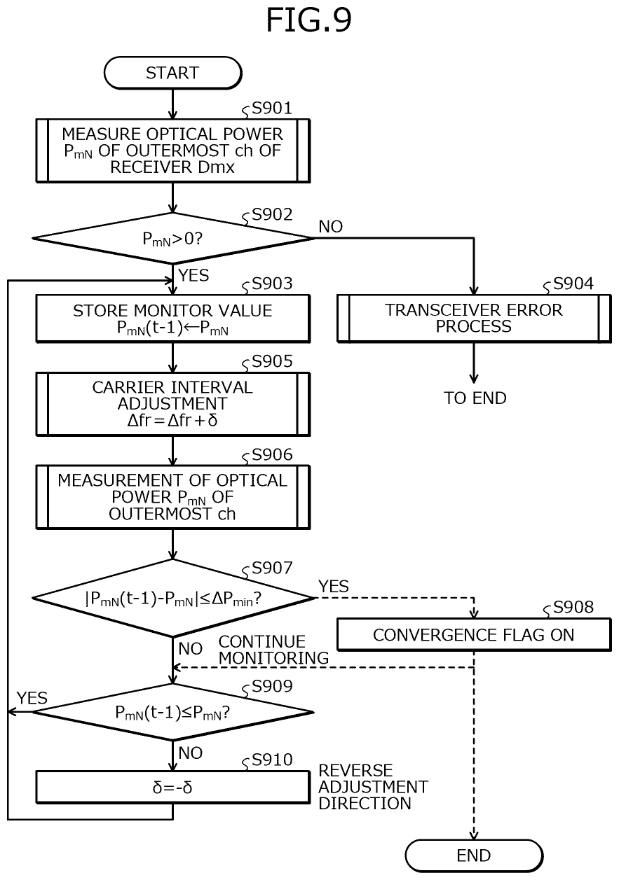

FIG. 9 is a flowchart depicting an example of control by the controller. The controller 120 performs the following control 1. to 3. on the transceiver 100 thereof asynchronously with an opposing transceiver.

1. The controller 120 monitors the optical power (P_{mN}), using the optical monitor 141d installed at the outermost output port light of the Dmx 141 of the receiver 140. The outermost output port is an output port whose center frequency of a subcarrier (channel) optical spectrum is the largest or the smallest. 2. The controller 120 controls the carrier interval so that the monitor value (the optical power) of the optical monitor 141d is maximized. For example, the controller 120 compares the current monitor value P_{mN} and the previous monitor value P_{mN} (t−1) and when P_{mN} (t−1)≤P_{mN}, does not change the direction of adjustment (the direction of adjustment for the frequency) of the carrier interval. When P_{mN} (t−1)>P_{mN}, the controller 120 reverses the direction of adjustment of the carrier interval. 3. The controller 120 adjusts and transmits the carrier interval Δfᵣ, where Δfᵣ=Δfᵣ(t−1)+δ (δ: adjustment amount of carrier interval).

The control example depicted in FIG. 9 is described. In FIG. 9, the control indicated by solid lines is control related to the carrier interval. Dashed lines indicate control for device operation of the transceiver 100 itself.

First, the controller 120 measures the optical power P_{mN}, using the optical monitor 141d of the outermost channel of the Dmx 141 of the receiver 140 (step S901).

Next, the controller 120 determines whether the measured optical power satisfies P_{mN}>0 (step S902). When the optical power satisfies P_{mN}>0 (step S902: YES), the controller 120 transitions to the control at step S903 and when the optical power does not satisfy P_{mN}>0 (step S902: NO), the controller 120 transitions to the control at step S904.

At step S903, the controller 120 stores the measured monitor value P_{mN} to a storage unit (step S903) and transitions to the control at step S905. As the storage unit, for example, the memory 802 depicted in FIG. 8 is used. The stored monitor value P_{mN} is used as the previous monitor value P_{mN} (t−1) in the next execution of the control.

At step S904, the controller 120 determines that the transceiver 100 thereof has an error and performs a predetermined transceiver error process (step S904), ending the above process.

At step S905, the controller 120 adjusts the carrier interval Δfᵣ. For example, according to Δfᵣ=Δfᵣ+δ, the carrier interval Δfᵣ is increased by the adjustment amount δ.

Next, the controller 120, again, measures the optical power P_{mN}, using the optical monitor 141d of the outermost channel of the Dmx 141 of the receiver 140 (step S906). Then, the controller 120 reads out the previous monitor value P_{mN} (t−1) from the storage unit, obtains an absolute value of the difference of the current monitor value P_{mN} and the previous monitor value P_{mN}(t−1), and determines whether the absolute value is not more than a predetermined difference threshold ΔPₘᵢₙ (|P_{mN}(t−1)−P_{mN}|≤ΔPₘᵢₙ) (step S907).

When the condition at step S907 not satisfied (|P_{mN}(t−1)−P_{mN}|>ΔPₘᵢₙ, step S907: NO), the controller 120 transitions to the control at step S909. At step S909, the controller 120 determines whether the previous monitor value P_{mN}(t−1) is not more than the current monitor value P_{mN}(P_{mN}(t−1)≤P_{mN}) (step S909).

When the determination result is that the previous monitor value P_{mN}(t−1) is not more than the current monitor value P_{mN}(P_{mN}(t−1)≤P_{mN}) (step S909: YES), the controller 120 returns to the control at step S903. On the other hand, when the previous monitor value P_{mN}(t−1) exceeds the current monitor value P_{mN}(P_{mN}(t−1)>P_{mN}) (step S909: NO), the controller 120 reverses (−δ) the adjustment direction of the carrier interval (step S910) and returns to the control at step S903.

Further, when the condition at step S907 is satisfied (|P_{mN}(t−1)−P_{mN}|≤ΔPₘᵢₙ, step S907: YES), the controller 120 turns on a convergence flag indicating that the above control of the carrier interval has converged (step S908) and ends the above control. Without limitation hereto, even after the control at step S908 performed, monitoring of the carrier interval continues and thus, the controller 120 may transition to the control at step S909, at a certain time, after a predetermined period elapses, etc.

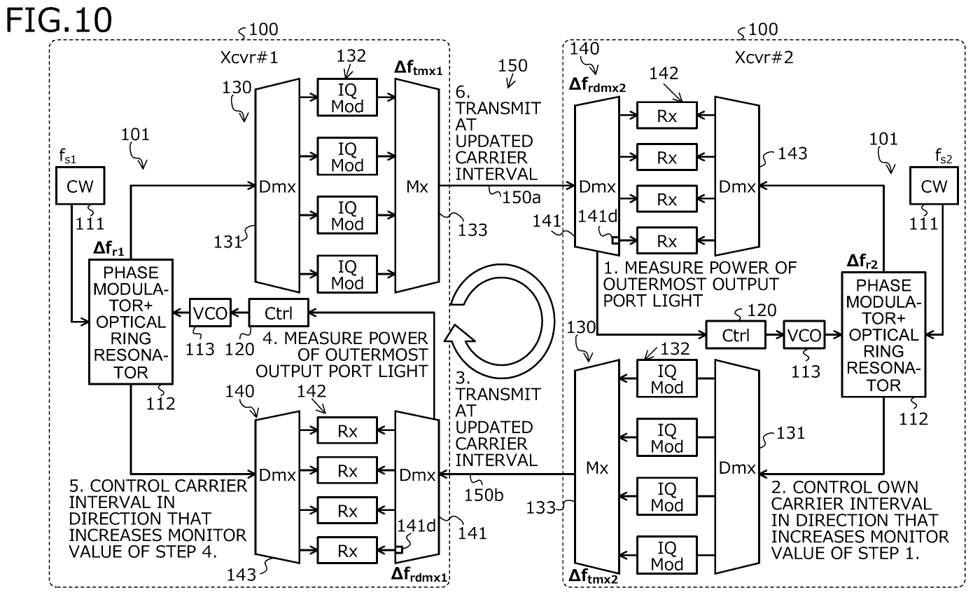

FIG. 10 is a diagram depicting an example of overall control of the optical transmission system of the embodiment. In FIG. 10, components identical to those depicted in FIG. 1 are given the same reference characters as those used in FIG. 1. An example in which the controllers 120, 120 of the pair of transceivers (Xcvr #1, Xcvr #2) of the transmission system perform coordinated control is described. Here, a first transceiver (Xcvr #1) has a CW light frequency fₛ₁, the carrier interval Δfᵣ₁, a transmitting channel frequency interval Δfₜₘₓ₁, and a receiving channel frequency interval Δf_{rdmx1}. A second transceiver (Xcvr #2) has a CW light frequency_{fs2}, the carrier interval Δfᵣ₂, a transmitting channel frequency interval Δfₜₘₓ₂, and a receiving channel frequency interval Δf_{rdmx2}.

In the example of coordinated control depicted in FIG. 10, first, the controller (Ctrl) 120 of the first transceiver (Xcvr #2) performs the following control 1. to 3. 1. The controller (Ctrl) 120 of the first transceiver (Xcvr #2) detects the optical power (P_{mN}) of the outermost frequency, using the optical monitor 141d of the Dmx 141 of the receiver 140. 2. The controller of the first transceiver (Xcvr #2) controls the carrier interval Δfᵣ₂ output by the phase modulator 112 of the transmitter 130 of the first transceiver (Xcvr #2) in a direction that increases the current monitor value detected by the optical monitor 141d. 3. At the transmitter 130, the Mx 133 transmits and outputs an optical signal having the channel frequency interval Δfₜₘₓ₂ to the optical transmission path 150b by the updated carrier interval.

Next, the controller (Ctrl) 120 of the second transceiver (Xcvr #1) performs the following control 4. to 6. 4. The controller (Ctrl) 120 of the second transceiver (Xcvr #1) detects the optical power (P_{mN}) for the outermost frequency, using the optical monitor 141d of the optical demultiplexer (Dmx) 141 of the receiver 140. 5. The controller (Ctrl) 120 of the second transceiver (Xcvr #1) controls the carrier interval Δfᵣ₁ output by the phase modulator 112 of the transmitter 130 of the second transceiver (Xcvr #1), in a direction that increases the current monitor value detected by the optical monitor 141d. 6. At the transmitter 130, the optical multiplexer (Mx) 133 transmits and outputs an optical signal having the channel frequency interval Δfₜₘₓ₁ to the optical transmission path 150a, by the updated carrier interval.

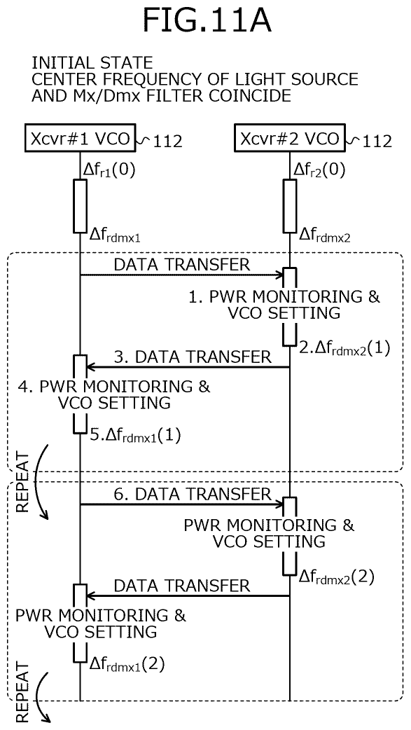

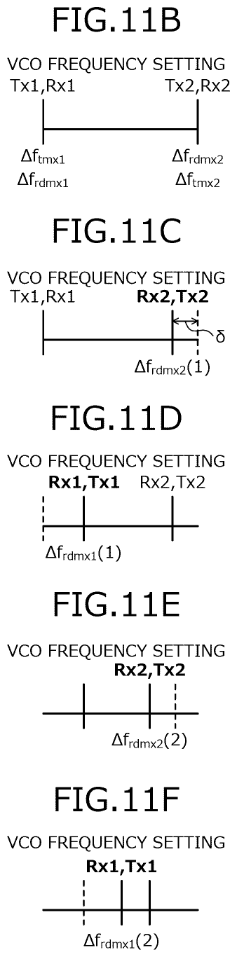

FIG. 11A is a sequence diagram of the example of overall control of the optical transmission system of the embodiment. FIG. 11A depicts the above control 1. to 6. of the controllers (Ctrl) 120 of the pair of transceivers (Xcvr #1, Xcvr #2) and FIGS. 11B, 11C, 11D, 11E, and 11F depict an example of frequency control of the VCOs 113, corresponding to the control example depicted in FIG. 10.

FIGS. 11B, 11C, 11D, 11E, and 11F are diagrams vertically depicting changing states of an optical signal Tx to be transmitted and an optical signal Rx to be received, due to changing frequency settings of the VCOs 113, FIGS. 11B, 11C, 11D, 11E, and 11F further depicting changing states of the transmitting channel frequency intervals Δfₜₘₓ₁, Δfₜₘₓ₂, the receiving channel frequency intervals Δf_{rdmx1}, Δf_{rdmx2} (a horizontal axis indicates frequency) due to control.

In the initial state of control depicted in FIG. 11A, the filters of the Mx 133 and the Dmx 141 and the center frequency of the laser light source 111 conform with each other (FIG. 11B). In the initial state (0), the transceiver Xcvr #1 has the carrier interval Δfᵣ₁ (0) and the receiving channel frequency interval Δf_{rdmx1}; and an optical signal Tx1 to be transmitted and an optical signal Rx1 to be received have the channel frequency intervals Δfₜₘₓ₁, Δf_{rdmx1}. Further, the transceiver Xcvr #2 has the carrier interval Δfᵣ₂ (0) and the receiving channel frequency interval Δf_{rdmx2}; and the optical signals Tx2, Rx2 to be transmitted and received, respectively, have the channel frequency intervals Δfᵣₐₘₓ₂, Δfₜₘₓ₂.

Further, during the first (1) adjustment control, an optical signal is transmitted (data transfer) from the transceiver Xcvr #1. In response, 1. the transceiver Xcvr #2 detects the optical power (P_{mN}) of the outermost frequency, using the optical monitor 141d of the Dmx 141 of the receiver 140. 2. Next, the transceiver Xcvr #2 controls the carrier interval Δfᵣ₂ output by the phase modulator 112 of the transmitter 130 of the transceiver Xcvr #2 in a direction that increases the current monitor value detected by the optical monitor 141d. By performing control corresponding to the frequency interval deviation, as depicted in FIG. 11C, the channel frequency interval Δf_{rdmx2} is changed by the adjustment amount δ to the channel frequency interval Δf_{rdmx2} (1).

3. At the transceiver Xcvr #2 thereafter, the Mx 133 of the transmitter 130 transmits and outputs an optical signal having the channel frequency interval Δfₜₘₓ₂ to the optical transmission path 150b by the updated carrier interval (data transfer).

4. Thereafter, with respect to the received optical signal, the transceiver Xcvr #1 detects the optical power (P_{mN}) for the outermost frequency, using the optical monitor 141d of the optical demultiplexer (Dmx) 141 of the receiver 140. 5. Next, the transceiver Xcvr #1 controls the carrier interval Δfᵣ₁ output by the phase modulator 112 of the transmitter 130 of the transceiver Xcvr #1, in a direction that increases the current monitor value detected by the optical monitor 141d. By performing control corresponding to the frequency interval deviation, as depicted in FIG. 11D, the channel frequency interval Δf_{rdmx1} is changed to the channel frequency interval Δf_{rdmx1}(1).

6. Thereafter, during the second (2) adjustment control, at the transceiver Xcvr #1, the optical multiplexer (Mx) 133 of the transmitter 130 transmits and outputs an optical signal having the channel frequency interval Δfₜₘₓ₁(1) to the optical transmission path 150a, by the updated carrier interval.

Thereafter, the controllers (Ctrl) 120 of the pair of transceivers (Xcvr #1, Xcvr #2) repeatedly perform the above control 1. to 6. By the above control for reducing deviation of the carrier interval and the channel frequency interval, as depicted in FIGS. 11E and 11F, the channel frequency intervals Δf_{rdmx2}, Δf_{rdmx1} Of the optical signals Tx1, Rx1, Tx2, Rx2 transmitted and received in the entire optical transmission system can be brought closer to each other.

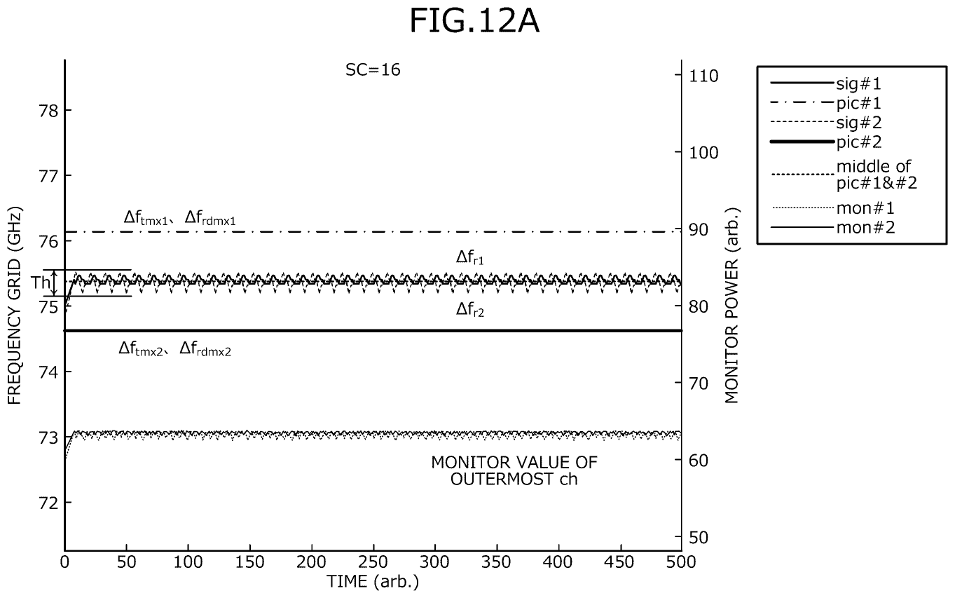

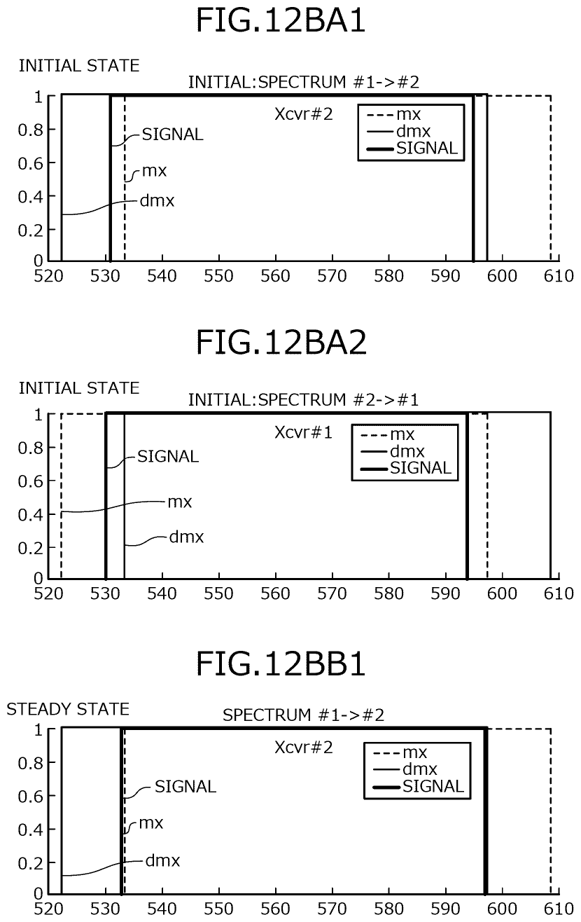

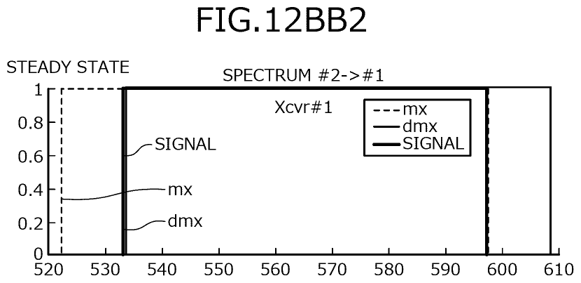

FIG. 12A is a diagram depicting an example of convergence by performing the control according to the embodiment. In FIG. 12A, a horizontal axis indicates time, a vertical axis (left side) indicates frequency, and the subcarrier count (SC)=16. Further, a vertical axis (right side) indicates monitor values 1, 2 detected at the outermost channel (the outermost output port, the optical monitor 141d).

Of the pair of transceivers 100, the transceiver Xcvr #1 has the channel frequency intervals Δfₜₘₓ₁, Δf_{rdmx1} and the transceiver Xcvr #2 has the channel frequency intervals Δfₜₘₓ₂, Δf_{rdmx2}. When control starts (time 0), the optical power of the monitor values 1, 2 of the pair of transceivers 100 (Xcvr #1, Xcvr #2) is weak and the carrier intervals (Δfᵣ₁, Δfᵣ₂) are positioned outside of a range of a predetermined threshold Th. However, by performing the control described above, the carrier intervals (Δfᵣ₁, Δfᵣ₂) are quickly positioned (converge) within a range of the threshold Th.

FIGS. 12BA1, 12BA2, 12BB1, and 12BB2 are diagrams depicting spectrum distribution of the outermost channel before and after control. A horizontal axis indicates frequency, and a vertical axis indicates the optical power. In the initial state depicted in FIGS. 12BA1 and 12BA2, at the transceiver Xcvr #2, the spectrum mx of the Mx 133 deviates toward the high-frequency side, the spectrum dmx of the Dmx 141 deviates toward the low-frequency side, and the low-frequency side of the spectrum of an optical signal (sig) is cut off at the low-frequency end of the spectrum mx. Further, at the transceiver Xcvr #1, the spectrum mx of the Mx 133 deviates toward the low-frequency side, the spectrum dmx of the Dmx 141 deviates toward the high-frequency side, and the low-frequency side of the spectrum of the optical signal (sig) is cut off at the low-frequency end of the spectrum dmx.

After the above control is performed, in the steady-state depicted in FIGS. 12BB1 and 12BB2, at both the transceiver Xcvr #1 and the transceiver Xcvr #2, the signal band of the optical signal (sig) converges within a band where the spectrum mx of the Mx 133 and the spectrum dmx of the Dmx 141 overlap.

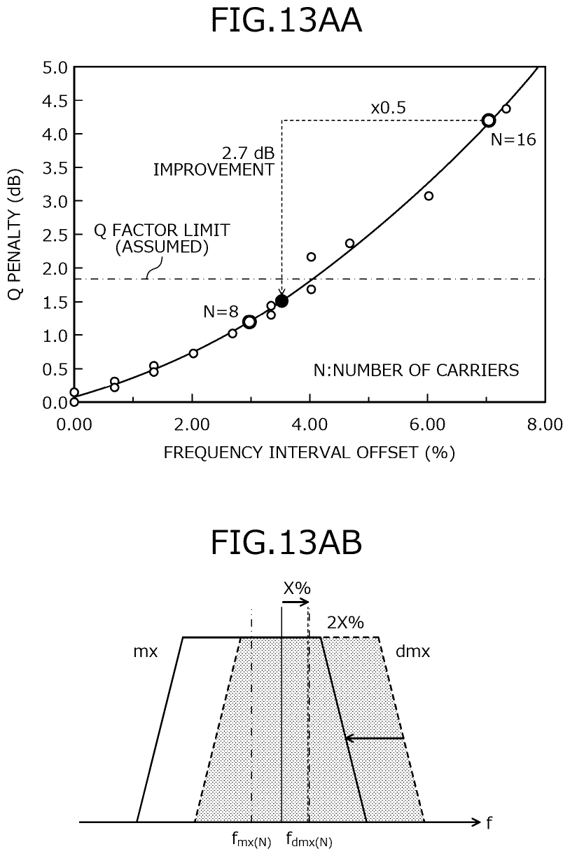

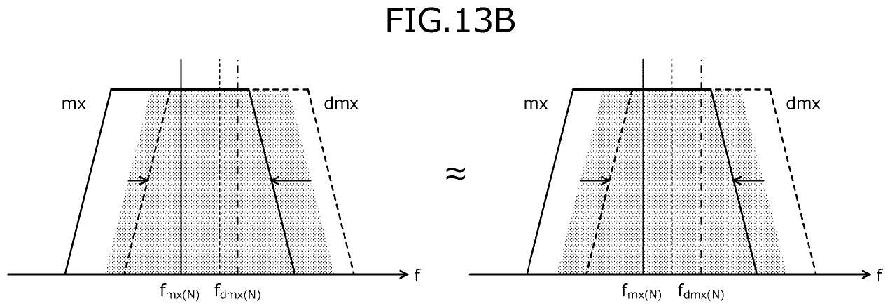

FIGS. 13AA, 13AB, and 13B are diagrams for describing effects obtained by the embodiment. FIG. 13AA is a same graph as that depicted in FIG. 5BA, a horizontal axis indicating frequency interval offset (%) and a vertical axis indicating Q factor penalty (dB). FIG. 13AB a bandwidth state of subcarriers N after control corresponding to Mx/Dmx frequency interval deviation according to the embodiment. In the embodiment, the carrier interval Δfᵣ of a transmission signal is controlled to be intermediate value of the Mx channel frequency interval Δfₜₘₓ of the transmitter and the Dmx channel frequency interval Δf_{rdmx} of the opposing receiver. As a result, f_{mx(N)} is positioned at the intermediate value of the bandwidth mx of the Mx 133 and f_{dmx(N)} is positioned at the intermediate value of the bandwidth dmx of the Dmx 141.

In actuality, as depicted in FIG. 13B, while the signal spectrum is asymmetrically filtered by the Mx 133/Dmx 141, the effect was estimated assuming the signal spectrum, including the states in FIG. 13B, is approximately filtered to a target.

According to the embodiment, in an instance of a same carrier count as conventionally, deviation of the carrier interval and the Mx/Dmx channel frequency interval becomes ½ and the Q factor is improved. For example, assuming the carrier count N=16, the Q factor penalty can be improved about 3 dB.

Further, in a case of a Q factor limit, the deviation of the carrier interval and the Mx/Dmx channel frequency interval becomes ½ and it becomes possible to exceed the Q factor limit. For example, as seen in FIG. 13AA, conventionally, the upper limit of the subcarrier count is N=8 whereas in the embodiment, the subcarrier count is increased (about two times) to about N=16.

In the embodiment described above as a first embodiment, the VCO 113 and the phase modulator 112 in a single transceiver 100 are used for both transmission and reception, however, in a second embodiment described hereinafter, an example is described in which the VCO 113 and the phase modulator 112 are provided separately for transmission and reception.

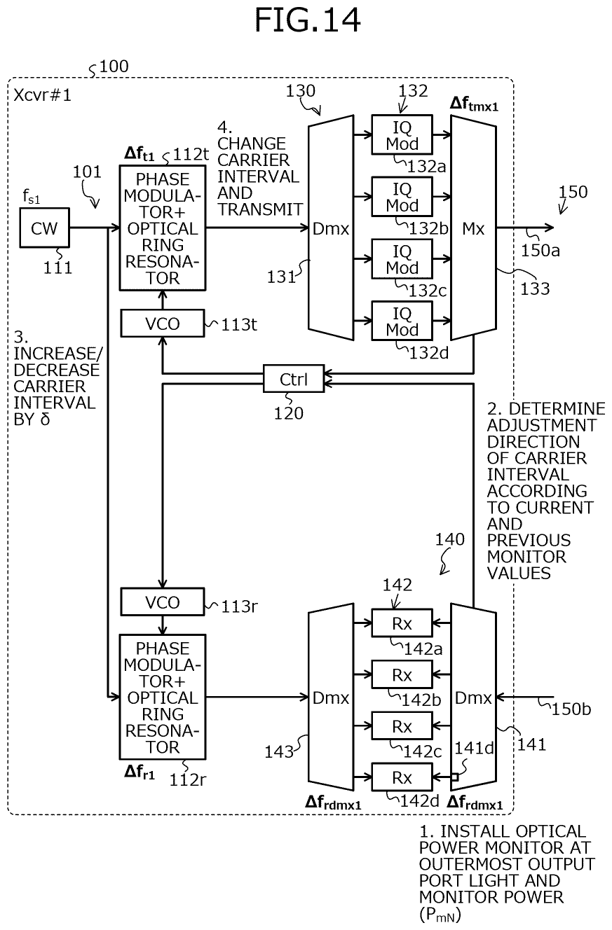

FIG. 14 is a diagram depicting an example of a configuration of the optical transceiver of the second embodiment. In FIG. 14, components identical to those depicted in FIG. 1 are given the reference characters used in FIG. 1. In the configuration example depicted in FIG. 14, a VCO 113t and a phase modulator 112t are disposed on the transmission side while a VCO 113r and a phase modulator 112r are disposed on the reception side.

The controller (Ctrl) 120 implements the following control 1. to 4. 1. The controller (Ctrl) 120 detects the optical power (P_{mN}) for the outermost frequency, using the optical monitor 141d of the optical demultiplexer (Dmx) 141 of the receiver 140. 2. The controller (Ctrl) 120 compares the current monitor value and the previous monitor value detected by the optical monitor 141d and determines the direction of adjustment (increase or decrease) for the carrier intervals Δfₜ₁, Δfᵣ₁ so that the value of the optical power detected by the optical monitor 141d is maximized. 3. The controller (Ctrl) 120 adjusts (increases or decreases) the carrier intervals Δfₜ₁, Δfᵣ₁ output by the phase modulator 112 of the transmitter 130 by the predetermined amount (δ) according to the direction of adjustment determined for the carrier intervals Δfₜ₁, Δfᵣ₁. 4. As a result, the transmitter 130 outputs, to the optical transmission path 150a, an optical signal to which the optical multiplexer (Mx) 133 imparts the channel frequency interval Δfₜₘₓ₁. The receiver 140 outputs, to the optical receivers 142, LO light to which the optical demultiplexer (demultiplexer: Dmx) 143 imparts the channel frequency interval Δf_{rdmx1}.

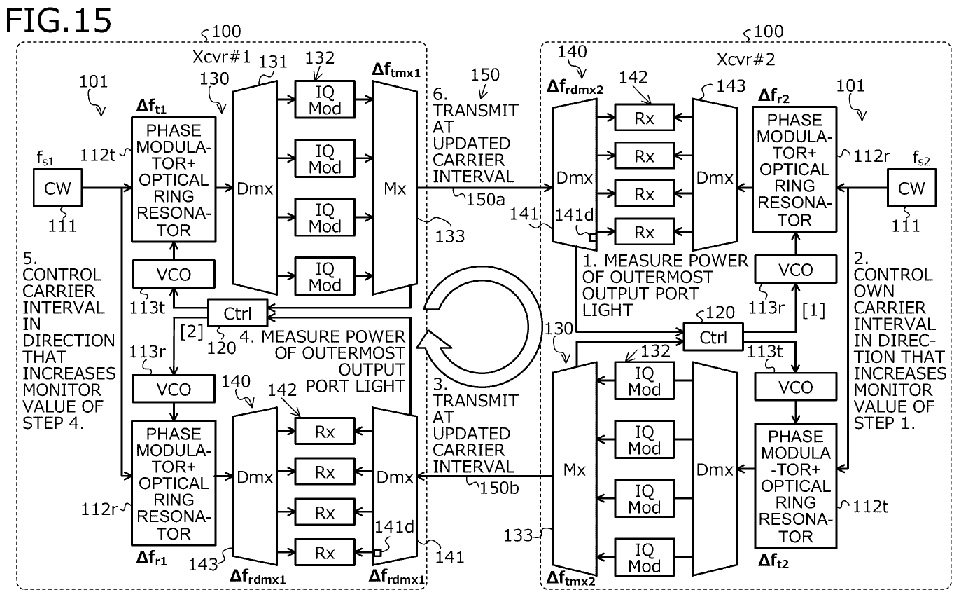

FIG. 15 is a diagram depicting an example of overall control of an optical transmission system of the second embodiment. In FIG. 15, components identical to those depicted in FIG. 14 are given the same reference characters used in FIG. 14. An example of control performed in cooperation by the controllers 120, 120 of the pair of transceivers (Xcvr #1, Xcvr #2) of a transmission system is described.

First, the controller (Ctrl) 120 of the first transceiver (Xcvr #2) performs the following control 1. to 3. 1. The controller (Ctrl) 120 of the first transceiver (Xcvr #2) detects the optical power (P_{mN}) of the outermost frequency, using the optical monitor 141d of the Dmx 141 of the receiver 140. 2. The controller (Ctrl) 120 of the first transceiver (Xcvr #2) controls the carrier intervals Δfₜ₂, Δfᵣ₂ output by the phase modulator 112 of the transmitter 130 of the first transceiver (Xcvr #2) in a direction that increases the current monitor value detected by the optical monitor 141d. 3. At the transmitter 130, the Mx 133 transmits and outputs an optical signal having the channel frequency interval Δfₜₘₓ₂ to the optical transmission path 150b, by the updated carrier interval.

Next, the controller (Ctrl) 120 of the second transceiver (Xcvr #1) performs the following control 4. to 6. 4. The controller (Ctrl) 120 of the second transceiver (Xcvr #1) detects the optical power (P_{mN}) for the outermost frequency, using the optical monitor 141d of the optical demultiplexer (Dmx) 141 of the receiver 140. 5. The controller (Ctrl) 120 of the second transceiver (Xcvr #1) controls the carrier intervals Δfₜ₁, Δfᵣ₁ output by the phase modulator 112 of the transmitter 130 of the second transceiver (Xcvr #1), in a direction that increases the current monitor value detected by the optical monitor 141d. 6. At the transmitter 130, the optical multiplexer (Mx) 133 transmits and outputs an optical signal having the channel frequency interval Δfₜₘₓ₁ to the optical transmission path 150a, by the updated carrier interval.

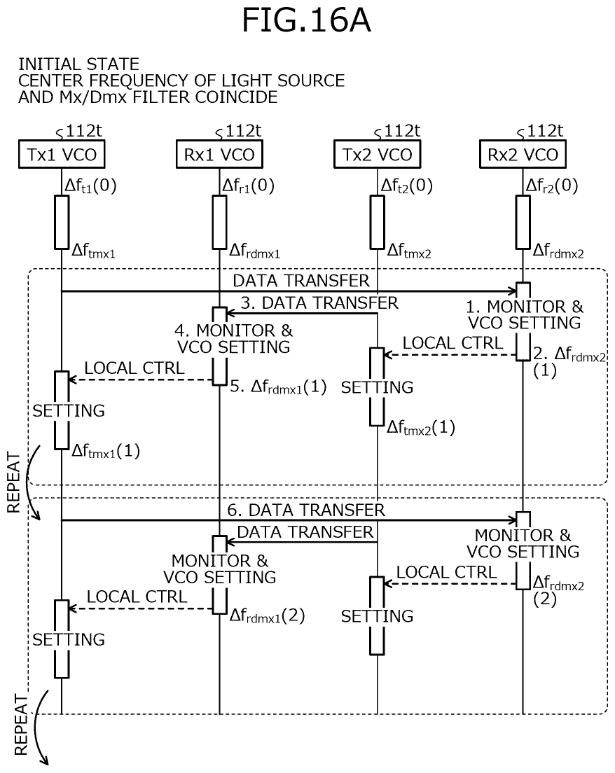

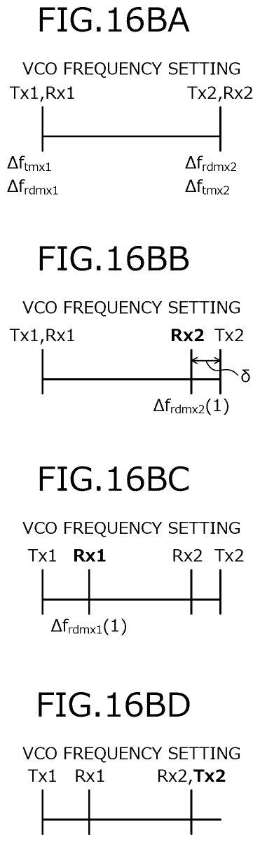

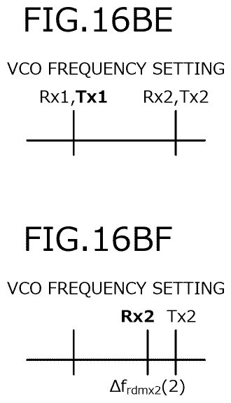

FIG. 16A is a sequence diagram of the example of overall control of the optical transmission system of the second embodiment. FIG. 16A depicts the above control 1. to 6. of the controllers (Ctrl) 120 of the pair of transceivers (Xcvr #1, Xcvr #2), corresponding to control example depicted in FIG. 15.

FIGS. 16BA, 16BB, 16BC, 16BD, 16BE, and 16BF are diagrams depicting an example of frequency control of the VCO of the second embodiment. FIGS. 16BA to 16BF vertically depict changing states of the optical signal Tx to be transmitted and the optical signal Rx to be received, based on changing the frequency settings of the VCOs 113 (113t, 113r), and changing states of the transmitting channel frequency intervals Δfₜₘₓ₁, Δfₜₘₓ₂ and the receiving channel frequency intervals Δf_{rdmx1}, Δf_{rdmx2} (a horizontal axis indicates frequency) due to control.

In the initial state of control depicted in FIG. 16A, the filters of the Mx 133 and the Dmx 141 and the center frequency of the laser light source 111 conform with each other (FIG. 16BA). In the initial state (0), the transceiver Xcvr #1 has the carrier interval Δfₜ₁ (0) and the channel frequency interval Δfₜₘₓ₁ of the optical signal Tx1 on the transmission side, and the carrier interval Δfᵣ₁ (0) and the channel frequency interval Δf_{rdmx1} of the optical signal Rx1 on the reception side. The transceiver Xcvr #2 has the carrier interval Δfₜ₂ (0) and the channel frequency interval Δfₜₘₓ₂ of the optical signal Tx2 on the transmission side, and the carrier interval Δfᵣ₂ (0) and the channel frequency interval Δf_{rdmx2} of the optical signal Rx2 on the reception side.

Further, during the first (1) adjustment control, an optical signal is transmitted (data transfer) from the transceiver Xcvr #1. In response, 1. the transceiver Xcvr #2 detects the optical power (P_{mN}) of the outermost frequency of the optical signal Rx2, using the optical monitor 141d of the Dmx 141 of the receiver 140. 2. Next, the transceiver Xcvr #2 controls the carrier interval Δfᵣ₂ output by the phase modulator 112r via the VCO 113r of the transceiver Xcvr #2 in a direction that increases the current monitor value detected by the optical monitor 141d. By performing control corresponding to the frequency interval deviation, as depicted in FIG. 16BB, the channel frequency interval Δf_{rdmx2} is changed by the adjustment amount δ to the channel frequency interval Δf_{rdmx2}(1). 3. The transmitter 130 transmits the optical signal Tx2 by the channel frequency interval Δfᵣₐₘₓ₂ to the transceiver Xcvr #1 and in response, the transceiver Xcvr #1 receives the optical signal Rx1 of the channel frequency interval Δf_{rdmx1}(1) (FIG. 16BB).

At the transmitter 130, via the VCO 113t, the phase modulator 112t changes the optical signal Tx2 to the channel frequency interval Δfₜₘₓ₂(1), according to the updated channel frequency interval Δfᵣₐₘₓ₂(1) (Rx2=Tx2, FIG. 16BD).

With respect to the received optical signal, 4. the transceiver Xcvr #1 detects the optical power (P_{mN}) for the outermost frequency, using the optical monitor 141d of the optical demultiplexer (Dmx) 141 of the receiver 140. 5. Next, the transceiver Xcvr #1 controls the carrier interval Δfᵣ₁ of the receiver 140 of the transceiver Xcvr #1 in a direction that increases the current monitor value detected by the optical monitor 141d. By performing control corresponding to the frequency interval deviation, the optical signal Rx1 is changed to the channel frequency interval Δf_{rdmx1}(1) (FIG. 16BC).

At the transmitter 130, via the VCO 113t, the phase modulator 112t changes the optical signal Tx1 to the channel frequency interval Δfₜₘₓ₁(1), according to the updated channel frequency interval Δf_{rdmx1}(1)(Rx1=Tx1, FIG. 16BE).

6. Thereafter, during the second (2) adjustment control, at the transceiver Xcvr #1, the optical multiplexer (Mx) 133 of the transmitter 130 transmits and outputs the optical signal Tx1 having the channel frequency interval Δfₜₘₓ₁(1) to the optical transmission path 150a, by the updated carrier interval.

Subsequently, the controllers (Ctrl) 120 of the pair of transceivers (Xcvr #1, Xcvr #2) repeatedly perform the above control 1. to 6. By the above control for reducing deviation of the carrier interval and the channel frequency interval, as depicted in FIG. 16BF, the channel frequency intervals Δf_{rdmx2}, Δf_{rdmx1} of the optical signals Tx1, Rx1, Tx2, Rx2 transmitted and received in the entire optical transmission system can be gradually brought closer to each other.

According to the second embodiment, the VCO 113 and the phase modulator 112 are each disposed in the transmitter 130 and the receiver 140. As a result, according to the MX/Dmx error on the transmission side and on the reception side, deviation of the carrier interval and the channel frequency interval of each can be reduced.

The described optical transceiver of the embodiments has a multiwavelength light source that outputs light of multiple optical frequencies having a predetermined carrier interval, a transmitter, a receiver, and a controller. The transmitter includes multiple optical modulators that generate optical signals by modulating, based on data, the lights output by the multiwavelength light source; the transmitter further includes an optical multiplexer that has a predetermined channel frequency interval and multiplexes the optical signals output by the optical modulators, and outputs the multiplexed optical signals to a first optical transmission path for transmission. The receiver includes an optical demultiplexer that has a predetermined channel frequency interval and demultiplexes, into multiple optical signals, an optical signal on a second optical transmission path for reception, the receiver further including multiple optical receivers that perform coherent detection with respect to the optical signals output by the optical demultiplexer and demodulate data, the coherent detection being performed using light of the multiwavelength light source. The controller performs control of a carrier interval of the multiwavelength light source, based on the optical power of the optical signals output by the optical demultiplexer of the receiver, and adjusts a channel frequency interval of the optical multiplexer of the transmitter, with respect to the carrier interval. The optical multiplexer and the optical demultiplexer have different filter characteristics due to manufacturing and deviation occurs in the carrier interval and the channel frequency interval in the initial state, however, by using the above control, deviation in the channel frequency interval output by the optical multiplexer of the transmitter can be suppressed relative to the carrier interval and optical frequency interval to be optically transmitted can be optimally adjusted.

Further, in the optical transceiver of the embodiment, the controller may perform the control so that the carrier interval becomes an intermediate value of the channel frequency interval of the optical multiplexer of the transmitter and the channel frequency interval of the optical demultiplexer of the receiver. As a result, a spectrum component of the optical signal cut by the filter characteristics of the optical demultiplexer can be suppressed and it becomes possible to enhance transmission characteristics such as the Q factor.

Further, in the optical transceiver of the embodiment, the demultiplexer may have an optical monitor that detects the optical power of an output port where the center frequency of the optical spectrum of the optical signals is largest or smallest and the controller may perform control for adjusting the carrier interval so that the optical power detected by the optical monitor is maximized. For example, by providing a single optical monitor at the outermost output port of the signal band in which the greatest frequency deviation error occurs, multiple optical frequency intervals can be easily and efficiently adjusted.

Further, in the optical transceiver of the embodiment, the controller may compare the current output power and the previous output power detected by the optical monitor, and based on a result of the comparison, may control the direction of adjustment and the adjustment amount for the frequency of the carrier interval. The control by the controller can be performed over time during optical transmission operations, thereby making it possible to constantly maintain optimal optical frequency intervals that are optically transmitted.

Further, in the optical transceiver of the embodiment, the optical multiplexer and the optical demultiplexer may be formed on a single optical chip. As a result, the filter characteristics of the optical multiplexer and the optical demultiplexer can be made nearly the same and it becomes possible to enhance adjustment accuracy.

Further, in the optical transceiver of the embodiment, as the multiwavelength light source, various forms may be used. For example, as the multiwavelength light source, a device may be used that includes a light source that outputs light, for example, continuous light, a voltage-controlled oscillator, and a phase modulator to which the light from the light source is input and that outputs light of multiple optical frequencies based on a control voltage of the voltage-controlled oscillator. In this instance, the transmitter includes an optical demultiplexer that demultiplexes the light of the multiple optical frequencies output by the phase modulator and outputs the demultiplexed lights to multiple optical modulators; and the receiver includes an optical demultiplexer that demultiplexes the light of the multiple optical frequencies output by the phase modulator and outputs the demultiplexed lights to multiple optical receivers. Additionally, as the multiwavelength light source, an array light source that outputs light of multiple frequencies may be used and, in this instance, the light of multiple frequencies of the array light source suffices to be output to the optical modulators and the optical receivers directly, and the optical demultiplexers become unnecessary.

Further, in the optical transceiver of the embodiment, the transmitter and the receiver may each have a phase modulator and a voltage-controlled oscillator. As a result, it becomes possible to reduce the deviation of the carrier interval and the channel frequency interval, according to the MX/Dmx error on the transmission side and the reception side.

Further, the optical transmission system of the embodiment can be configured by the pair of opposing optical transceivers with a transmission path therebetween. In this instance, each of the optical transceivers can perform control of the carrier interval in the optical transceiver thereof, based on optical signals transmitted and received between the pair of optical transceivers.

According to one aspect of the invention, an effect is achieved in that multiple optical frequency intervals for optical transmission can be optimally adjusted.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical transceiver, comprising:
a multiwavelength light source configured to output multifrequency light and having a predetermined carrier interval;
a transmitter;
a receiver; and
a controller, wherein
the transmitter has:
a plurality of optical modulators that generate a plurality of optical signals by optically modulating, based on data, the multifrequency light output by the multiwavelength light source; and
an optical multiplexer that has a first channel frequency interval and multiplexes the plurality of optical signals output by the plurality of optical modulators, the optical multiplexer outputting the multiplexed plurality of optical signals to a first optical transmission path for transmission;
the receiver has:
an optical demultiplexer that has a second channel frequency interval and demultiplexes an optical signal of a second optical transmission path for reception, into the plurality of optical signals; and
a plurality of optical receivers that perform coherent detection with respect to the plurality of optical signals output by the optical demultiplexer, and demodulate the data, the coherent detection being performed using the multifrequency light of the multiwavelength light source; and
the controller is configured to perform control of the carrier interval of the multiwavelength light source and adjust the first channel frequency interval of the optical multiplexer of the transmitter with respect to the carrier interval, the control being performed based on an optical power of the plurality of optical signals output by the optical multiplexer of the receiver.

2. The optical transceiver according to claim 1, wherein
the controller performs the control so that the carrier interval becomes an intermediate value of the first channel frequency interval of the optical multiplexer of the transmitter and the second channel frequency interval of the optical demultiplexer of the receiver.

3. The optical transceiver according to claim 1, wherein
the demultiplexer has an optical monitor that detects the optical power of an output port where a center frequency of an optical spectrum of the plurality of optical signals is largest or smallest, and
the controller performs the control including increasing or decreasing the carrier interval so that the optical power detected by the optical monitor is maximized.

4. The optical transceiver according to claim 3, wherein the controller performs the control including comparing a current output power and a previous output power detected by the optical monitor and based on a result of comparison, controlling a direction of adjustment and an adjustment amount for a frequency of the carrier interval.

5. The optical transceiver according to claim 1, wherein the optical multiplexer and the optical demultiplexer are formed on a single optical chip.

6. The optical transceiver according to claim 1, wherein
the multiwavelength light source has:
a voltage-controlled oscillator;
a light source that outputs light; and
a phase modulator to which the light of the light source is input, the phase modulator outputting the multifrequency light, based on a control voltage of the voltage-controlled oscillator;
the transmitter has an optical demultiplexer that demultiplexes and outputs the multifrequency light to the plurality of optical modulators, and
the receiver has an optical demultiplexer that demultiplexes and outputs the multifrequency light to the plurality of optical receivers.

7. The optical transceiver according to claim 1, wherein
the multiwavelength light source has:
a light source that outputs light;
a transmitter-dedicated voltage-controlled oscillator;
a transmitter-dedicated phase modulator to which the light from the light source is input, the transmitter-dedicated phase modulator outputting the multifrequency light, based on a control voltage of the transmitter-dedicated voltage-controlled oscillator;
a receiver-dedicated voltage-controlled oscillator;
a receiver-dedicated phase modulator to which the light from the light source is input, the receiver-dedicated phase modulator outputting the multifrequency light, based on a control voltage of the receiver-dedicated voltage-controlled oscillator;
the transmitter has an optical demultiplexer that demultiplexes and outputs, to the plurality of optical modulators, the multifrequency light output by the transmitter-dedicated phase modulator, and
the receiver has an optical demultiplexer that demultiplexes and outputs, to the plurality of optical receivers, the multifrequency light output by the receiver-dedicated phase modulator.

8. An optical transmission system, comprising a pair of opposing optical transceivers with an optical transmission path therebetween, each of the pair of opposing optical transceivers comprising:
a multiwavelength light source configured to output multifrequency light and having a predetermined carrier interval;
a transmitter;
a receiver; and
a controller, wherein
the transmitter has:
a plurality of optical modulators that generate a plurality of optical signals by optically modulating, based on data, the multifrequency light output by the multiwavelength light source; and
an optical multiplexer that has a first channel frequency interval and multiplexes the plurality of optical signals output by the plurality of optical modulators, the optical multiplexer outputting the multiplexed plurality of optical signals to a first optical transmission path for transmission;
the receiver has:
an optical demultiplexer that has a second channel frequency interval and demultiplexes an optical signal of a second optical transmission path for reception, into the plurality of optical signals; and
a plurality of optical receivers that perform coherent detection with respect to the plurality of optical signals output by the optical demultiplexer, and demodulate the data, the coherent detection being performed using the multifrequency light of the multiwavelength light source; and
the controller is configured to transmit and receive the plurality of optical signals with respect to an opposing one of the pair of transceivers and at the each of the pair of transceivers, perform control of the carrier interval of the multiwavelength light source and adjust the first channel frequency interval of the optical multiplexer of the transmitter with respect to the carrier interval, the control being performed based on an optical power of the plurality of optical signals output by the optical multiplexer of the receiver.

9. A carrier interval control method of an optical transceiver having a multiwavelength light source configured to output multifrequency light and having a predetermined carrier interval, a transmitter, a receiver, and a controller, wherein
the transmitter has:
a plurality of optical modulators that generate a plurality of optical signals by optically modulating, based on data, the multifrequency light output by the multiwavelength light source; and
an optical multiplexer that has a first channel frequency interval and multiplexes the plurality of optical signals output by the plurality of optical modulators, the optical multiplexer outputting the multiplexed plurality of optical signals to a first optical transmission path for transmission; and
the receiver has:
an optical demultiplexer that has a second channel frequency interval and demultiplexes an optical signal of a second optical transmission path for reception, into the plurality of optical signals; and
a plurality of optical receivers that perform coherent detection with respect to the plurality of optical signals output by the optical demultiplexer, and demodulate the data, the coherent detection being performed using the multifrequency light of the multiwavelength light source, the carrier interval control method of the optical transceiver, comprising
performing, by the controller, control of the carrier interval of the multiwavelength light source and adjusting, by the controller, the first channel frequency interval of the optical multiplexer of the transmitter with respect to the carrier interval, the control being performed based on an optical power of the plurality of optical signals output by the optical multiplexer of the receiver.

10. The carrier interval control method according to claim 9, wherein the performing the control includes performing the control so that the carrier interval becomes an intermediate value of the first channel frequency interval of the optical multiplexer of the transmitter and the second channel frequency interval of the optical demultiplexer of the receiver.
